(19) United States
(12) Patent Application Publication
(10) Pub. No.: US 2005/0157215 A1
(43) Pub. Date: Jul. 21, 2005

(54) Method and apparatus for detecting an inactive channel selecting resource in a television converter

(75) Inventors: Dan J. Minnick, Littleton, CO (US); David A. Kummer, Highlands Ranch, CO (US); Gary W. Dalmadge, Broomfield, CO (US); Stephen D. Bartlett, Larkspur, CO (US)

Correspondence Address: MERCHANT & GOULD PC, P.O. BOX 2903, MINNEAPOLIS, MN, 55402-0903, US

(73) Assignee: EchoStar Techonologies Corporation

(21) Appl. No.: 10/940,107

(22) Filed: Sep. 13, 2004

Related U.S. Application Data
(60) Provisional application No. 60/608,937, filed on Sep. 11, 2003.

(51) Int. Cl. H04N 7/025; H04N 5/50; H04N 5/44; H04N 7/16; H04N 7/173; G06F 13/00; H04N 5/445; H04N 7/10

(52) U.S. Cl. 348/725; 725/100; 725/131; 725/151; 725/35; 348/731

(57) ABSTRACT

Methods and Apparatuses are disclosed that allow a television converter device to determine when a channel selector in the device is inactive.

### FIELD OF THE INVENTION

The present invention relates to television converters for receiving and delivering channels of television programming. More particularly, the invention relates to a method and apparatus for determining when a channel selecting resource in a television converter is inactive.

### BACKGROUND OF THE INVENTION

Modern television converters, often colloquially referred to as set top boxes (set-top-boxes) because they usually are located on or next to a connected television, now support wide array of functions and services that go beyond simple channel selection. It is now common for set-top-boxes to also be personal video recorders (PVRs) through the inclusion of a storage device, typically a hard drive similar to those used in personal computers, along with the associated control hardware and software, in the set-top-box. Many set-top-boxes also allow users to directly order pay-per-view movies from the programming provider. Increasingly, set-top-boxes use microprocessors executing operating system software similar to those in personal computers to control the additional functions and devices now common in set-top-boxes.

In order to maintain efficient operation modern set-top-boxes, from time to time, should perform various housekeeping functions. Such housekeeping functions are common in personal computers and include activities like defragnientation of hard drives, disk scanning for errors, memory testing, downloading updated software, spinning down hard drives when not in use, and performing various other system maintenance operations. As set-top-boxes have become more complicated, the need for performing such housekeeping functions has drastically increased. Additionally, many housekeeping functions, especially those that require the downloading of information, require the use of a channel selecting resource. However, because modem set-top-boxes typically contain a single channel selecting resource, housekeeping functions requiring a channel selecting resource cannot be performed while the channel selecting resource is delivering television programming that a user is viewing. This creates a problem as set-top-boxes are typically designed such that when they are on the channel selecting resource is delivering television programming. Thus, set-top-boxes typically do not perform housekeeping functions requiring a channel selecting resource while the set-top-box is on, because of the risk of interfering with a user's viewing of television programming.

### SUMMARY OF THE INVENTION

The present invention provides methods that determine when a channel selecting resource in a content management device such as a television converter or set top box, is inactive. By this we mean that it is not being actively used to watch television programs. Inactive channel selecting resources may then be used by the device as necessary for housekeeping and maintenance. The present invention also includes television converters that include an inactivity detector.

### BRIEF DESCRIPTION OF THE DRAWINGS

FIG. 1 illustrates a home entertainment system utilizing a set-top-box in accordance with an embodiment of the present invention.

FIG. 2 is a functional block diagram of a set-top-box in accordance with an embodiment of the present invention.

FIG. 3 illustrates one embodiment of a set-top-box that determines when a channel selecting resource is inactive by determining when a connected TV is off.

FIG. 4 illustrates another embodiment of a set-top-box that determines when a channel selecting resource is inactive.

FIG. 5 illustrates an embodiment of a method for determining an inactive channel selecting resource in a set-top-box in accordance with an embodiment of the present invention.

### DETAILED DESCRIPTION OF THE INVENTION

In this specification, the present invention will be described using methods and systems related to subscriber satellite television service. This specific description is not meant to limit the invention to that one embodiment. The present invention may also be applicable to cable television systems, broadcast television systems or other television systems. The present invention is also described in terms of digital video recording (DVR) devices. The present invention may also be applicable to digital-versatile-disc (DVD) recording devices or other television recording devices. One skilled in the art will recognize that the present invention can apply elsewhere.

As a general matter, the disclosure uses the term “signal.” One skilled in the art will recognize that the signal may be any digital or analog signal. Those signals may include, but are not limited to, a bit, a specified set of bits, an A/C signal, or a D/C signal. Uses of the term “signal” in the description may include any of these different interpretations. It will also be understood to one skilled in the art that the term “connected” is not limited to a physical connection but can refer to any means of communicatively or operatively coupling two devices.

As another general matter, the disclosure uses the terms “television converter,” “receiver,” “set-top-box,” “television receiving device,” “television receiver,” “television recording device,” “satellite set-top-box,” “satellite receiver,” “cable set-top-box,” “cable receiver,” and “television tuner” to refer interchangeably to a converter device or electronic equipment that has the capacity to acquire, process and distribute one or more television signals transmitted by broadcast, cable, telephone or satellite distributors. “Digital video recorder (DVR)” and “personal video recorder (PVR)” refer interchangeably to devices that can digitally record and play back television signals and that may implement trick functions including, but not limited to, fast-forward, rewind and pause. As set forth in this specification and the figures pertaining thereto, DVR and PVR functionality or devices may be combined with a television converter. The signals transmitted by these broadcast, cable, telephone or satellite distributors may include, individually or in any combination, internet, radio, television or telephonic data or information. One skilled in the art will recognize that a television converter device may be implemented as an external self-enclosed unit, a plurality of external self-enclosed units or as an internal unit housed within a television. One skilled in the art will recognize that the present invention can apply to analog and digital satellite set-top-boxes.

As yet another general matter, it will be understood by one skilled in the art that the term “television” refers to a television set or video display that may contain an integrated television converter device (e.g., an internal cable-ready television tuner housed inside a television) or, alternatively, that is connected to an external television converter device (e.g., an external set-top-box connected via cabling to a television). A further example of an external television converter device is the EchoStar Dish PVR 721, Part Number 106525, combination satellite set-top-box and PVR. For the remainder of this disclosure, specific embodiments will be described using a television converter device that implements satellite technology.

Finally, as a general matter, it should be understood that satellite television signals may be very different from broadcast television or other types of signals. Satellite signals may include multiplexed, packetized, and modulated digital signals. Once multiplexed, packetized and modulated, one analog satellite transmission may carry digital data representing several television stations or service providers. Some examples of service providers include HBO™, CSPAN™, ABC™, CBS™, or ESPN™. In satellite television, a service provider can also be compared to a “channel.”

The term “channel,” as used in this description, carries a different meaning from its normal connotation. In broadcast television, different analog signals of a television station may be carried on a carrier frequency and its sub-channels. A tuner in a television may then acquire and process these signals. In broadcast television, the term channel has thus become synonymous with the sub-channel or the station on that sub-channel. The normal connotation of the term “channel” is therefore not always appropriate to describe satellite television transmissions where multiple stations may be multiplexed onto a single carrier frequency. Satellite television distributors, however, may organize the satellite data into a group of different “virtual channels.” These virtual channels give the impression that the satellite television programs (the service providers) are placed in channels. This impression may assist user operation of the satellite set-top-box since it models an analog television or analog receiving device. The virtual channels may appear in the electronic program guide (EPG) data and the user may choose programming by selecting a virtual channel. For instance, the user can select HBO, which may be on virtual channel 300, or CSPAN, which may be on virtual channel 210. These service providers or virtual channels are not necessarily carried in the same signal being sent from the same satellite. EPG data may come from a service provider (e.g., HBO), content provider (e.g., Disney), a third party (e.g., TV Guide) or from another outside entity.

Thus, in satellite television service a channel may not be the same as in broadcast television service. Rather, channels may be more properly termed service providers in satellite television service. The term “channel” will be used in this description to describe the service providers and the virtual channels they may occupy.

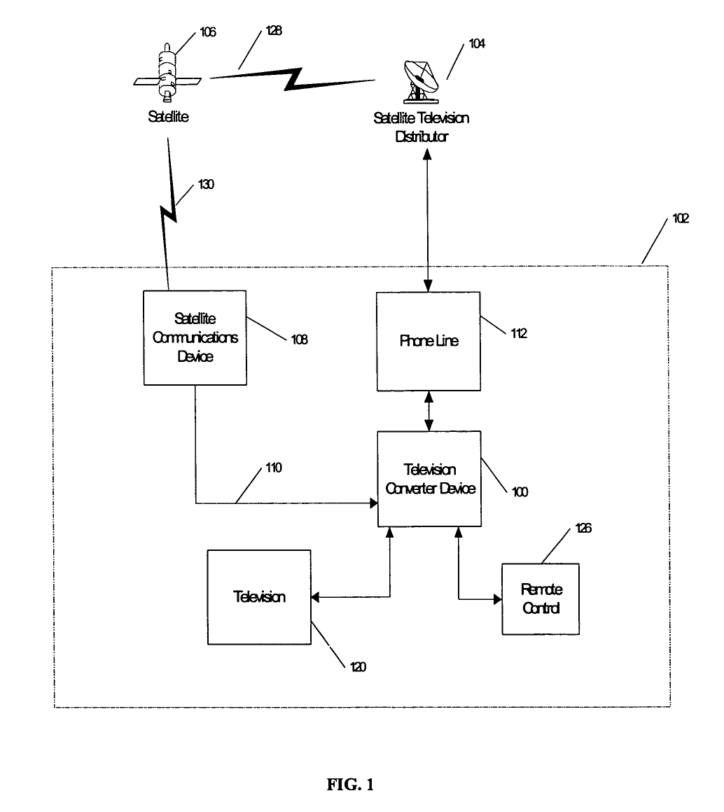

FIG. 1 presents an embodiment of a home entertainment system 102 that includes a television converter device 100 in the form of a satellite set-top-box. Generally, the satellite set-top-box 100 may receive one or more television signals from a cable television distributor (not shown), from a broadcast television distributor (not shown) or from a satellite television distributor 104. As a preferred embodiment, home entertainment system 102 receives signals from satellite television distributor 104. One skilled in the art will recognize that set-top-box 100 may also receive video-digital subscriber line (DSL), DSL, Internet, wireless and other signals from content or video distributors. The satellite set-top-box 100 may process television signals and may send the processed signals to peripheral electronic devices, such as a television 120 and remote control 126. The satellite set-top-box 100 also may accept commands from a remote control 126 or other peripheral electronic devices. More detail about the functionality of the satellite set-top-box 100 is provided below.

To further describe the home entertainment system, embodiments relating to receiving satellite television signals will be explained in more detail. A satellite television distributor 104 may transmit one or more satellite television signals 128 to one or more satellites 106. Satellite television distributors may utilize several satellites 106 to relay the satellite television signals to a subscriber. Each satellite 106 may have several transponders. Transponders transmit the signal 130 from the satellite to the subscriber. For example, these signals 130 may be transmitted at a frequency of 2150 Mhz.

A transponder may also polarize the transmitted signal 130 in several ways. One form of polarization in satellite transmissions is circular polarization. For example, transponders of satellite 106 may transmit two signals (together as signal 130) on the same transponder, one signal that is right-hand polarized and another signal that is left-hand polarized. In other words, two signals may be simultaneously transmitted with opposite polarizations. The opposite polarizations may prevent interference. One skilled in the art will recognize that other ways of polarizing signals are possible.

The polarized signals can be received at satellite communication device 108. The satellite communication device 108 may include one or more of the components that follow. One component of satellite communication device 108 may be a satellite dish. A satellite dish can focus the signal on one or more low-noise block filters (LNBF), also referred to as low-noise block down converters (LNBDC). The LNBFs may de-polarize and initially process the signal. This initial processing may include filtering noise from the signal and down-converting the signal. Down-conversion is sometimes required to transmit the signal 110 through certain cables, such as coaxial cables. The signal 110 arrives at the television converter device 100 via cabling. One skilled in the art will recognize that other methods and other systems of delivering the satellite signal 110 to the satellite set-top-box 100 may be possible.

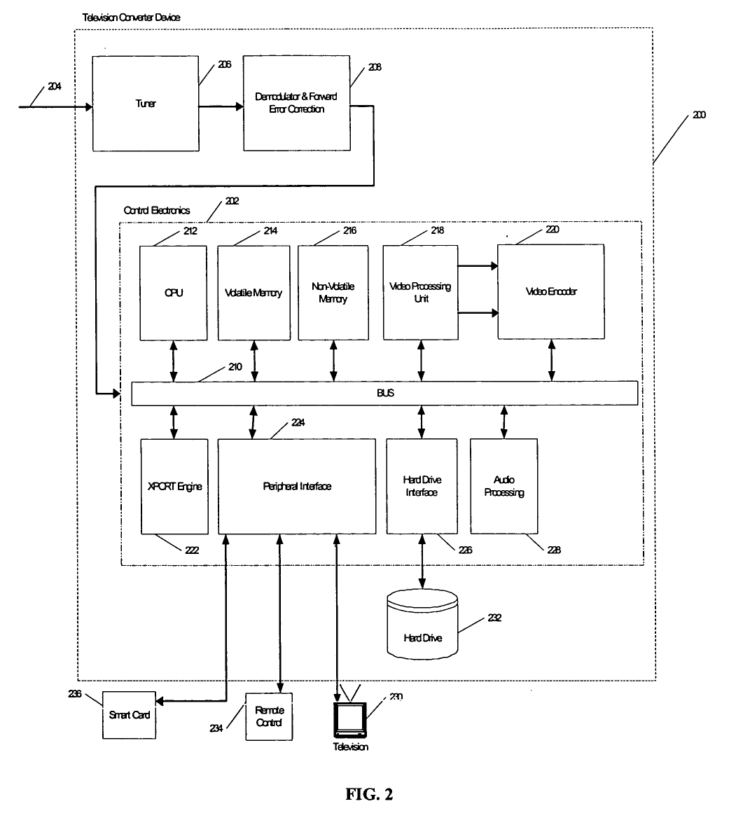

FIG. 2 provides a high level block diagram for the satellite television converter device 100, 200 with DVR functionality in accordance with the present invention.

The signal 110, 204 that arrives at the satellite set top box 200 may undergo extensive processing. The television converter 200 may include one or more channel selecting resources. To receive signals from a broadcast television distributor, one embodiment of channel selecting resources may include one or more tuners that may tune to analog signals carried on a carrier frequency and its subchannels because, as previously set forth, there exists a correspondence from the analog subchannel of a carrier signal and a television station. As set forth before, the selection of channels from digital signals may be very different from the selection of channels from analog signals. Digital signals may include many different virtual channels that are multiplexed onto a single carrier frequency. Thus, channel selecting resources also correspond to satellite set-top-box components for receiving and processing packetized digital data (e.g., packets of television programming that may correspond to different television stations) that may be delivered to the satellite set-top-box 100 by multiple carrier frequencies from one or more satellite transponders. One skilled in the art will recognize that many different configurations of channel selecting resources are possible and within the scope of this invention. For example, one embodiment of a channel selecting resource in a satellite set-top-box 100 may include one or more tuners in combination with a demultiplexer and demodulator. Channel selecting resources may therefore include one or more tuners individually, one or more tuners in combination with a demultiplexer (e.g., the XPORT Engine 222 of the present embodiment) or one or more tuners in combination with one or more set-top-box components or devices, including, but not limited to, the control electronics 202, a demodulator or demultiplexer. Channel selecting resources may also be allocated to receive and deliver television programming to one or more display devices (e.g., a television) or components within the set-top-box 100. As a preferred embodiment of a channel selecting resource, a tuner device 206 acquires a satellite signal 204 from satellite television distributor 104 and delivers the signal 204 to other set-top-box components that may include, but is not limited to, a demodulation unit 208 and demultiplexing unit 222.

One part of a channel selecting resource, such as tuner device 206, may initially process the satellite signal 204. Tuner device 206 may also receive subscriber commands in the form of signals from control electronics unit 202. Signals from control electronics unit 202 may include, but are not limited to, a signal to tune to a transponder as part of the process of selecting a certain channel for viewing on a peripheral device. One skilled in the art will recognize that the tuner device 206 may include fewer, more, or different components.

After receiving the signal 204, one of the first steps by a channel selecting resource of the present embodiment may be to demodulate 208 the signal 204. The signal 204 may arrive as an analog signal that “carries” data (e.g., data is modulated onto the analog signal). Demodulation 208 may be accomplished by reversing the modulation process. Modulation can be done in several ways. Modulation may include amplitude modulation (AM) or frequency modulation (FM). If the carried data is digital, modulation methods include, but are not limited to, biphase-shift keying (BPSK), quadraphase-shift keying (QPSK), or eight-phase shift keying (8 PSK). One skilled in the art will recognize that other methods of modulating and demodulating the signal 204 may be possible. Another one of the first steps may also be to error check 208 signal 204. One example of error checking 208 is forward error checking (FEC). FEC 208 may include, but is not limited to, inspecting parity bit or bits that may accompany signal 204. One skilled in the art will recognize that many methods for error checking are possible. For the purposes of discussion, an embodiment using digital data will be discussed below. However, one skilled in the art will recognize that systems with analog data or combined analog and digital data are also possible and contemplated herein.

In this embodiment, satellite set-top-box 200 contains control electronics unit 202 that receives satellite signal 204. One skilled in the art will recognize that control electronics 202 may receive other signals, including, but not limited to, signals from a cable or broadcast television distributor. One example of a control electronics unit 202 is the STMicroelectronics STiS517 Low-Cost Interactive Set-top Box Decoder, Part No. 7424736A. In a preferred embodiment, control electronics unit 202 includes discrete electronic components combined into a single circuit with a shared bus 210. In other embodiments, control electronics unit 202 may be configured differently. For example, one or more of the control electronics unit 202 components in set-top-box 200 may be combined or omitted. The control electronics unit 202 may use a custom ASIC, such as from the LSILogic G11 family, or FPGA, such as from the Altera Stratix™ family. As a further example, one or more of the control electronics unit 202 components in set-top-box 200 may not share a bus 210, but may nonetheless be operatively connected by some other means. One skilled in the art will recognize that other configurations of set-top-box 200 and control electronics unit 202 are possible and within the scope of this invention. One skilled in the art will further recognize that some components of set-top-box 200 and control electronics unit 202 may be implemented in hardware or software. The control electronics unit 202 may operate under the control of a software program, firmware program, or some other program stored in memory or control logic. One skilled in the art will also recognize that the control electronics unit 202 may include other electronic components or structures to mediate or process signals.

Control electronics unit 202 may contain one or more central-processing-units (CPUs) 212 or processors. A preferred embodiment of control electronics unit 202 contains a single CPU 212 that is operatively connected to the shared bus. In one embodiment, CPU 212 may be used, among other things, for logical operations for set-top-box 200 functions including, but not limited to, channel selection, recording control, EPG display and control and system maintenance. Examples of commercially available CPUs 212 include the STMicroelectronics Enhanced ST20 32-bit VL-RISC, Motorola 68000 or Intel Pentium processors. One skilled in the art will recognize that the CPU 212 may be integrated with memory or other discrete electronics components.

Control electronics unit 202 may also contain one or more volatile memory components 214. Volatile memory components 214 may include, but are not limited to, one or more SDRAM memory chips. Similarly, control electronics unit 202 may contain non-volatile memory components 216. Non-volatile memory 216 may include one or more memory chips, including, but not limited to, ROM, SRAM, SDRAM and Flash ROM. One skilled in the art will recognize that volatile memory 214 and non-volatile memory 216 may be integrated within other electronics components. One skilled in the art will also recognize that other memory components may be included within set-top-box 200 and control electronics unit 202. One skilled in the art will recognize that memory 214, 216 may be used for many purposes, including, but not limited to, storing EPG data and storing data for use by CPU 212.

In a preferred embodiment, signal 204 is in digital form (e.g., a digital stream) after demodulation and error correction. For example, digital stream 204 may use, but is not limited to using, the digital video broadcasting (DVB) transport standard. As another part of the channel selecting resource of the present embodiment, the digital stream 204 may be multiplexed and therefore require demultiplexing by XPORT Engine 222. Demultiplexing 222, or demuxing, may include separating the bits of data into separate digital data streams. The digital streams may be packetized. Thus, the multiplexing of the separate digital data streams may not be bit-by-bit but packet-by-packet. The packet size may vary or may be constant. After demuxing 222 the packets, the separate digital data streams may be reassembled by placing related packets together in a continuous data stream 204.

Each of the separate digital data streams may also be encoded. Encoding is a method for representing data. Encoding may allow the data to be compressed. Compression can provide the system with increased bandwidth. One skilled in the art will recognize that several different encoding formats are possible. In satellite television, encoding formats may include the MPEG or MPEG2 standards. Beyond the raw data, the separate digital data streams may include forward error correction, headers, checksums, or other information. All of this different information may be included in the digital television signal 204 processed by the satellite set-top-box 100. Control electronics unit 202 may therefore include one or more video processing units 218 that, among other video processing operations, may decode encoded signal 204. In a preferred embodiment, video processing unit 218 may include, but is not limited to, a graphics processor, MPEG-2 decoder and a display compositor with separate on-screen display (OSD) control for peripheral devices. One skilled in the art will recognize that video processing unit 218 may also include other electronics, including, but not limited to, alpha blending, antialiasing, antiflutter and antiflicker filters, memory and video-rendering components.

Another discrete electronic component of control electronics unit 202 may be a video encoder unit 220. Video encoder unit 220 may work in combination with or independently from video processing unit 218. Video encoding unit 220 may encode digital stream 204 for output to one or more peripheral devices, including, but not limited to, a television. For example, video encoding unit 220 may encode digital stream 204 for RGB, CVBS, Y/C and YUV outputs. Encoding may allow program data to be compressed. As a preferred embodiment, video encoder 220 may translate digital stream into a signal using the NTSC, PAL or SECAM standards. One skilled in the art will recognize that video encoder unit 220 may include other functionality, may be integrated into other electronic components of satellite set-top-box 200, and may encode digital stream 204 using other standards, including, but not limited to, MPEG and MPEG2.

Control electronics unit 202 may also include one or more hard drive interfaces 226 and hard drives 232. In a preferred embodiment, television converter device 200 contains one hard drive interface 226 and hard drive 232. Hard drive 232 may be used for many purposes, including, but not limited to, storing recorded programs, buffering currently-playing programs (e.g., buffering a program may allow a user to pause or rewind a program), storing EPG data, storing commands or functions for the control electronics unit 202, storing timers or record events, and storing data for other devices within or connected to the satellite set-top-box 200. As another example, hard drive 232 may be used to temporarily store data for processing by CPU 212. In this example, the hard drive 232 may allow the processor 212 to separate EPG data arriving as part of digital stream 208. One skilled in the art will recognize that other storage devices and interfaces may be substituted for hard drive interface 226 and hard drive 232 and are within the scope of this invention. One skilled in the art will also recognize that hard drive interface 226 and hard drive 232 may separately or together include an integrated memory (e.g., a memory buffer, commonly known referred to as cache) and additional processing components or logic. One skilled in the art will also recognize that hard drive interface 226 may be integrated into peripheral interface 224 (described below). Finally, one skilled in the art will recognize that hard drive 232 may be external and connected to satellite set-top-box 200. For example, an external hard drive 232 may be connected to satellite set-top-box 200 using USB 2.0 or EEEE 1394 (FireWire) connections. Such an external hard drive may include a screen for portable viewing of programming stored on it.

An audio processing unit 228 may also be part of the control electronics unit 202. Audio processing unit 228 may decode the digital stream 204 for output to peripheral devices, including, but not limited to, a stereo, television speakers or portable audio or video players. For example, audio processing unit 228 may decode MPEG-1 layers I/II and layer III, Dolby Digital, Dolby ProLogic, SRS/TruSurround encoded audio in digital stream 204. Audio processing unit 228 may include one or more processors, memory components or digital to audio converter (DAC) systems. One skilled in the art will recognize that other audio processing components and functionality may be accomplished using audio processing unit 228.

A satellite set-top-box 200 may be connected to one or more peripheral electronic devices through peripheral interface 224. These peripheral devices may include a stereo (not shown), television 230, smart card 236, VCR (not shown), or other devices. In a preferred embodiment, home entertainment system 102 minimally contains, but is not limited to, a television 230 and smart card 236. Television 230 may serve many purposes, including, but not limited to, displaying television programming, displaying the EPG, displaying timer conflicts, and displaying other types of data, graphics and programming. Peripheral devices may receive and/or send signals from the satellite set-top-box 200. For instance, the television 230 may receive video and audio signals and a stereo may receive only audio signals. A camcorder (not shown), on the other hand, may send video or audio signals to the satellite set-top-box 100 or receive audio and video signals from the set-top-box to record. As another example, peripheral interface 224 may include a processor or other electronic components to permit an interface to content security devices such as an external “smart card.” In this example, peripheral interface 224 may then encrypt or decrypt content for output to other peripheral devices. Thus, peripheral interface 224 may perform one or more functions for multiple peripheral devices, including, but not limited to, the synchronous or asynchronous transfer of data between different peripheral devices (e.g., decrypting content using a smart card peripheral device and outputting decrypted content to a television at the same time). One skilled in the art will recognize that the peripheral devices may include many types of commercially available electronic devices.

The home entertainment system 102 may also include a remote control 126, 234 peripheral device, also sometimes referred to as a remote. The remote control 234 may be used to send commands to the satellite set-top-box 200. The remote control 234 may send commands via a wireless connection using, for example, infrared or UHF transmitters within the remote control 234. One example of an embodiment of a remote controller 234 is the EchoStar Technologies Corporation 721 Platinum Plus Remote, Part Number 121150, that includes an IR transmitter and an ultra high frequency (UHF) transmitter. The remote control 234 may be able to send signals to other peripheral electronic devices that form part of the home entertainment system 102, including, but not limited to, a television, stereo, VCR, or DVD player. The set-top-box 200 may also be able to send signals to the remote control 234, including, but not limited to, signals to configure the remote control 234 to operate other peripheral devices in home entertainment system 102. In some embodiments, the remote control 234 has a set of Light Emitting Diodes (LEDs). Some remote controls may include Liquid Crystal Displays (LCDs) or other screens. The remote control may include buttons, dials, or other man-machine interfaces. While the remote control 234 may often be the common means for a subscriber to communicate with the satellite set-top-box 200, one skilled in the art will recognize that other means of communicating with the set-top-box 200 are available, including, but not limited to attached keyboards, front panel buttons or touch screens.

The satellite set-top-box 200 may also include a remote control interface (not shown). A remote control interface may include any means for the user to communicate to the satellite set-top-box 200, and may be implemented using the peripheral interface 224 of control electronics unit 202 or by connecting a peripheral remote control interface device. In a preferred embodiment, a remote control interface may receive commands from one or more different remote controls 234. Remote control 234 may use infrared, UHF, or other communications technology. The remote control interface may therefore translate an input from the user into a format understandable by the control electronics unit 202. The translation systems may include, but are not limited to, electronic receivers and electronic relays. One skilled in the art will recognize that other means to receive and translate user inputs are possible.

Another peripheral device and connection to the satellite set-top-box 200 may include a phone line (not shown) and modem (not shown). Set-top-box 200 may use a modem and phone line to communicate with one or more outside entities or systems (e.g., satellite television distributor 104). The phone line may carry local or long-distance telephone service. One skilled in the art will recognize that the phone line may also carry other services, including, but not limited to, DSL service. These communications may include requesting pay-per-view programming, reporting of purchases (for example, pay-per-view purchases), obtaining updates to subscriber programming (e.g., updating EPG data), or receiving updates to software on the satellite set-top-box 100. For example, the phone line may communicate with the satellite set-top-box 100 using an RJ-11 style telephone connection. One skilled in the art will recognize that there are many other uses for this phone line connection. For example, EPG data may be transmitted to set-top-box 200 via phone line or in the satellite signal 204. One skilled in the art will recognize that the EPG data may be transmitted to set-top-box 200 by various other methods, systems and outside entities. Also, one skilled in the art will recognize that a phone line connection to satellite distributor 104 may represent other communication connections, including, but not limited to, wireless, Internet, or microwave communications connections. Another function of the phone line may be to periodically receive the EPG data.

As discussed previously, television converter 100 may select and deliver one or more channels of television programming from the digital stream 110. The set-top-box 100 may also continuously buffer the delivered television programming. In addition, the set-top-box 100 may periodically perform housekeeping functions. Many of these housekeeping functions may require the use of a channel selecting resource.

As set forth in the following embodiments, the set-top-box 100 may include software or hardware, referred to herein as an inactivity detector, which is capable of determining when a channel selecting resource is inactive. It should be understood that, in this context, an “inactive” channel selecting resource means a channel selecting resource that is available for performing functions, such as housekeeping, that do not interfere with a user's use of the satellite set-top-box 100. As described in the Background of the Invention, this definition is important because channel selecting resource may deliver television programming when a user is using a set-top-box. Thus, it is important to differentiate between those situations when a set-top-box is on but the user is not viewing delivered television programming (e.g., situations where a channel selecting resource is available for housekeeping and thus inactive by definition) and situations when the set-top-box is on and the user is viewing or recording the delivered television programming (i.e. the channel selecting resource is active and use of the channel selecting resource to perform housekeeping may interfere with the user's use of the set-top-box).

An inactivity detector may monitor one or more components of the home entertainment system 102 and determine when a channel selecting resource is inactive. Depending on the parameters monitored, the inactivity detector may be embodied in hardware or software that may be internal or external to the satellite set-top-box 100. In one embodiment, the inactivity detector may be an integrated component of the control electronics 202, a standalone circuit or a combination of the two. In another embodiment, the inactivity detector may take the form of external hardware that is connected to the peripheral interface 224 or other part of the set-top-box 100. In yet another embodiment, the inactivity detector may take the form of software within satellite set-top-box 100. The inactivity detector or satellite set-top-box 100 may graphically illustrate when a channel selecting resource is available for housekeeping functions. The inactivity detector may also be connected to internal components or parts of the set-top-box 100.

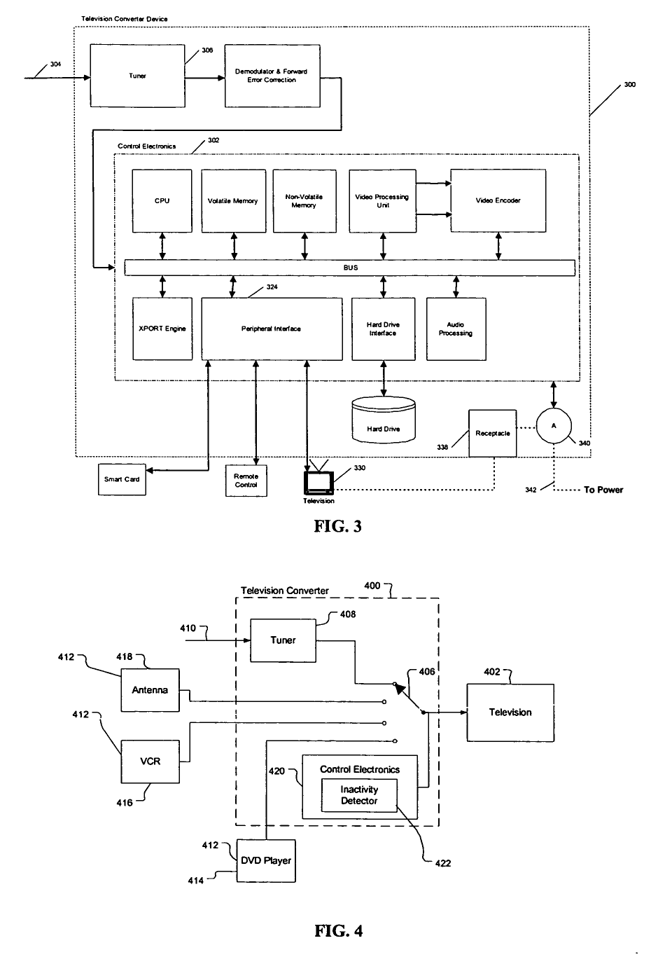

FIG. 3 illustrates an embodiment of a set-top-box 300 that may detect when a channel selecting resource, such as tuner 306, is inactive by determining whether a connected device, such as a television 330, is turned off. FIG. 3 shows a television converter 300 that is similar to the television converter of FIG. 2. In this embodiment, set-top-box 300 includes, but is not limited to, a tuner 306 that delivers television programming from a digital stream 304 to a connected television 330. The set-top-box 300 of this embodiment is further provided with one or more power receptacles 338 into which external devices may be connected, such as television 330, and through which they may receive power. For clarity, power connections are shown as dotted lines and set-top-box connections are shown as solid lines. Within the set-top-box 300 of this embodiment, the receptacle 338 is connected to the set-top-box's power connection 342 (e.g., a connection to an electrical outlet). Also within the set-top-box 300 of this embodiment is a monitor 340 that monitors the amount of power being drawn through the receptacle 338. In this embodiment, the monitor 340 may take the form of an amp-meter that monitors the amount of electrical current the television 330 is drawing. One skilled in the art will recognize that other types of monitors 340 are possible.

In a preferred embodiment, an inactivity detector is embodied in software within the control electronics 302. In this embodiment, the control electronics 302 and inactivity detector are connected to the monitor 340. When the television 330 is turned on, it will draw more power through the receptacle 338 than when it is turned off. By monitoring the difference in power use, the inactivity detector may determine when the television 330 is turned on or off. If the television 330 is turned off, then the inactivity detector may deem the tuner 306 to be inactive. The inactivity detector of this embodiment is illustrated as software within the control electronics unit 302. One skilled in the art will recognize that such an inactivity detector may also be implemented in the form of hardware, as a separate hardware circuit providing a signal to the control electronics 302 or as some combination of hardware and software. Any such implementation is considered within the scope of the invention as long as the inactivity detection may be performed.

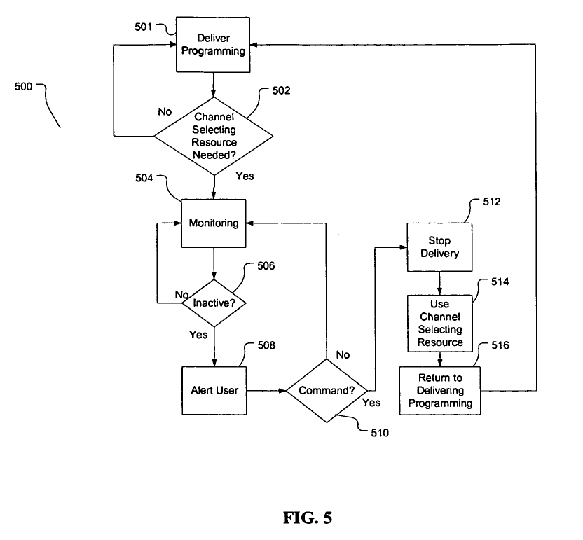

FIG. 4 illustrates a simplified embodiment of a set-top-box 400 that may determine when a channel selecting resource, such as tuner 408, is inactive by detecting when the connected television 402 is displaying television programming delivered from an external source of television programming 412. FIG. 4 shows a simplified illustration of a set-top-box 400 including, but not limited to, a tuner 408 that delivers television programming from a stream of multiple channels 410 to a connected television 402. The set-top-box 400 may also be connected to one or more external sources 412. In the embodiment shown in FIG.4, the set-top-box 400 is shown connected to three external television programming sources 412, illustrated as a DVD player 414, a VCR 416, and an antenna 418 for receiving broadcast television programming. In this embodiment, a device selector 406 is also provided that selects between delivering television programming from the tuner 408 or from one of the external sources 412. The device selector 406 may be accessed via a physical selector on the control panel of the set-top-box 400, one or more buttons on the set-top-box's remote controller or some combination of the two. In another embodiment, the device selector may be embodied as software in the control electronics 420. One skilled in the art will recognize that other ways of selecting devices are possible.

In this embodiment, inactivity detector 422 is embodied as software in the control electronics 420. The control electronics 420 and inactivity detector 422 are also connected to the device selector 406. In the present embodiment, when the user selects to view television programming from an external source 412, the user will not be viewing television programming delivered by the tuner 408. Thus, by monitoring the device selector 406, the inactivity detector 422 may determine when a channel selecting resource (e.g., tuner 408) is not delivering television programming to the TV and is, therefore, inactive.

One example of a device that may be easily adapted to perform in accordance with the embodiment shown in FIG. 4 is a set-top-box that includes a button for switching between a broadcast antenna and delivering television programming from the satellite dish. For example, a set-top-box and associated remote controller may include an ‘Off Air’ feature and remote controller button that causes the set-top-box to bypass the satellite programming and access an external antenna for receiving television programming broadcast over the air. In this situation, depending on the design of the set-top-box, the tuner may be inactive. Likewise, such capabilities for other television programming sources may be included in a set-top-box.

As set forth previously, one form of a channel selecting resource is a tuner. In the following embodiments, the term channel selecting resource is used to emphasize that, as set forth previously, the embodiments of methods for determining inactivity are not exclusive to the reception of digital signals. One skilled in the art will recognize that one or more tuners, working independently or in combination with other set-top-box 100 components, may allocate the resources necessary for receiving and displaying analog and digital channels.

FIG. 5 illustrates one embodiment of a method 500 for determining an inactive channel selecting resource in a set-top-box in accordance with an embodiment of the present invention. In the present embodiment, the method 500 delivers television programming via a channel selecting resource in a delivering operation 501. In this embodiment, the method 500 may be initiated by a first determination operation 502 that identifies when a channel selecting resource is needed by the set-top-box for purposes not directly related to user commands, including, but not limited to, housekeeping and maintenance duties, receiving forced downloads, or executing remotely set recording timers. Note that alternative embodiments of the method 500 may not include such first determination operation 502, or the determination operation 502 may be continuously ongoing regardless of any other operation in the set top box.

In the present embodiment, a set-top-box that is operating (i.e. it is connected to a power source) may monitor for one or more parameters in a monitoring operation 504. For example, in one embodiment, the set-top-box monitors whether the set-top-box is turned on or off. In another embodiment, the set-top-box monitors the power consumption of the television connected to the set-top-box. In other embodiments, the set-top-box may monitor such parameters as the time since a last command was issued from the remote controller, the commands issued by the remote controller, the time since the last command was issued to the set-top-box via buttons on the set-top-box, the actual commands sent to the television by the remote controller, and the source of television programming be provided to the television (e.g., from the set-top-box, a VCR, a DVD player or an external antenna).

One skilled in the art will recognize that many parameters may be monitored by the set-top-box to help determine whether the television or set-top-box is in use. One skilled in the art will also recognize that the monitored parameters may be limited by the hardware provided in the set-top-box. For example, the set-top-box may monitor the audio or visual output of the television if an appropriate sensor is provided. This example of a monitoring parameter may be particularly useful if the sensed output of the television may be compared to the programming recently delivered to the set-top-box. Such a comparison may help to determine whether the displayed programming matches the delivered programming and thus whether a channel selecting resource may be in use.

A determining operation 506 may then analyze one or more monitored parameters and determine whether the channel selecting resource (e.g., for satellite set-top-boxes with only one tuner) or the channel selecting resources (e.g., for satellite set-top-boxes with two or more tuners) are inactive or otherwise available for allocation by the set-top-box. This analysis may be simple or complex depending on the parameter. For example, in embodiments that monitor parameters to determine whether the set-top-box is turned on or whether the television is drawing current, the analysis may use a simple logic statement such as “if the set-top-box is off or if the current to the television is below some threshold, the channel selecting resource is inactive unless otherwise recording.”

Other parameters may require more analysis and may not necessarily be related to a “state” of a parameter, rather than to a sequence of occurrences. For example, one monitored parameter may be the commands sent by the remote controller to any device in the home entertainment center 102. In this example, the set-top-box may monitor the remote control command to turn off the television, the remote control commands to play or record from devices such as a VCR and DVD player, or the remote control command to switch the television to a different source. The analysis of some commands may be more complicated than a simple if-then-else type of algorithm. One example of a more complicated algorithm may be detecting whether commands are sent to a VCR and the television and then waiting a predetermined amount of time. In this example, if no commands to the set-top-box are received during the predetermined amount of time, multiple different television programs have been delivered by the set-top-box and the set-top-box is not recording, then the set-top-box may determine that a channel selecting resource is inactive as the user is likely watching a videotape. In yet another embodiment, the set-top-box may monitor whether a channel selecting resource is being used for recording television programming (e.g., such as using a channel selecting resource is used to record television programming to a hard drive).

In the present embodiment, based on the results of the analysis of the monitored parameters 504, the second determination operation 506 may deem the channel selecting resource to be inactive. The second determination operation 506, like the monitoring operation 504, may be substantially continuous operations. For example, upon receiving a new command, say a command to turn on the set-top-box or television or change a channel on the set-top-box, the determination operation 506 may determine that the channel selecting resource is active. In this example, determination operation 506 may require the set-top-box to stop whatever housekeeping or maintenance functions it may have been performing using the inactive channel selecting resource and return to active delivery of television programming. Use of an active channel selecting resource may include, but is not limited to, anticipating a user-desired channel (e.g., tuning to the previously viewed channel by the user in a recall operation). Also, in embodiments including more than one channel selecting resources, use of an active channel selecting resource may then be used for set-top-box functions, including, but not limited to, displaying picture-in-picture television programming (e.g., tuning the main display to one channel while simultaneously tuning to and displaying another channel that overlays the primary display).

In the present embodiment, after determining 506 that a channel selecting resource is inactive, the set-top-box may attempt to verify that a channel selecting resource is inactive by displaying a message to the user alerting the user 508 that the set-top-box may cease delivering television programming. In one embodiment, the user may be instructed to press a button on the remote control or the face of the set-top-box to prevent the set-top-box from interrupting delivery of television programming. A third determination operation 510 may then determine whether a command is received in response to the alert 508. If a command is received in response to the alert 508, then the channel selecting resource may be deemed active and the set-top-box may return to the monitoring operation 504. In this example, a return to monitoring operation 504 may affect the analysis of second determination operation 506.

In a preferred embodiment, if no such input from the user is detected within a specified period of time, the third determination operation 510 may confirm that the channel selecting resource is inactive. In this embodiment, the delivery of television programming from the set-top-box to the television may then be stopped in a stop delivery operation 512. The stop delivery operation 512 frees up the channel selecting resource for use by the set-top-box.

In a preferred embodiment, once delivery of television programming has stopped 512, a background use operation 514 may allocate the channel selecting resource for the necessary purpose. As discussed above, this purpose may be to receive a forced download of content or computer control instructions, perform housekeeping functions or other maintenance type duties. Another purpose may include, but is not limited to, allocating a channel selecting resource to a single television display device. For example, a set-top-box 100 with two or more channel selecting resources may use one channel selecting resources to display or record television programming while another channel selecting resource may simultaneously perform housekeeping functions, pre-tune another channel (e.g., tuning to the user's previously viewed channel), display picture-in-picture programming, or display another television program (e.g., a user may wish to view a channel while the set-top-box records another channel in the background). One skilled in the art will recognize that many ways of using an inactive channel selecting resource are possible and within the scope of this invention. Upon completion of the background use, the channel selecting resource may be returned 516 to normal television programming delivery 501. In a preferred embodiment, the return 516 to delivering programming operation delivers the channel the channel selecting resource was delivering before the stop delivery operation 512. After a return 516 to the delivery of programming 501, the set-top-box may return to normal operation.

Note that many different embodiments of the above method 500 may be possible and within the scope of the invention. In one embodiment, monitoring and analysis may be done continuously, while no other operations are performed until a need for a channel selecting resource arises.

Another embodiment of method 500 applies to set-top-boxes that do not need a channel selecting resource to deliver stored programming to a television. In this embodiment, when the set-top-box is delivering stored programming, the channel selecting resource may be determined to be inactive. In yet another embodiment, when a set-top-box finishes delivery of stored programming, the set-top-box may determine a channel selecting resource is inactive if it does not receive a user command to do something within a specified period of time.

It will be clear that the present invention is well adapted to attain the ends and advantages mentioned as well as those inherent therein. While presently preferred embodiments have been described for purposes of this disclosure, various changes and modifications may be made which are well within the scope of the present invention. For example, the method and apparatus presented above is applicable to devices such as set-top-boxes that have multiple channel selecting resources. For such set-top-boxes, each channel selecting resource may be monitored separately and separate determinations of inactivity made based on separate remote controllers or televisions associated with each channel selecting resource. Numerous other changes may be made which will readily suggest themselves to those skilled in the art and which are encompassed in the spirit of the invention disclosed and as defined in the appended claims.

1. A method for allocating resources for a television converter having at least one channel selecting resource comprising:
a. allocating a channel selecting resource for the receipt and display of television programming on a television display device;
b. receiving television programming via the channel selecting resource;
c. displaying said television programming on said television display device;
d. monitoring a parameter indicative of the use of said channel selecting resource;
e. determining that said channel selecting resource is inactive based on the monitored parameter; and
f. reallocating the use of said channel selecting resource based upon said determination of inactivity.

2. The method of claim 1 further comprising:
performing housekeeping functions when the channel selecting resource is inactive.

3. A method for allocating resources for a television converter having at least one channel selecting resource according to claim 1 wherein the step of monitoring a parameter indicative of the use of said channel selecting resource comprises measuring the power consumption of the television display device.

4. A method for allocating resources for a television converter having at least one channel selecting resource according to claim 1 wherein the step of monitoring a parameter indicative of the use of said channel selecting resource comprises monitoring when the television display device is turned off.

5. A method for allocating resources for a television converter having at least one channel selecting resource according to claim 4 wherein monitoring when the television display device is turned off comprises monitoring commands from a remote control for the television display device.

6. A method for allocating resources for a television converter having at least one channel selecting resource according to claim 5 wherein it is determined that the channel selecting resource is inactive when no signal has been received from the remote control for a predetermined amount of time.

7. A method for allocating resources for a television converter having at least one channel selecting resource according to claim 1 wherein the parameter monitored is the selected source of the television programming.

8. A method for allocating resources for a television converter having at least one channel selecting resource according to claim 1 wherein inactivity is not determined when the channel selecting resource is being used for recording television programming.

9. A method for allocating resources for a television converter having at least one channel selecting resource according to claim 1 wherein said television converter includes a second channel selecting resource.

10. A method for allocating resources for a television converter having at least one channel selecting resource according to claim 9 wherein said first and second channel selecting resources can be allocated to first and second television display devices.

11. A method for allocating resources for a television converter having at least one channel selecting resource according to claim 10 wherein if inactivity is detected in connection with said first channel selection resource, both channel selection resources are allocated to a single television display device.

12. A method for allocating resources for a television converter having at least one channel selecting resource according to claim 11 wherein one channel selecting resource provides television programming for a current user selected channel and the other channel selecting resource provides television programming for an anticipated user desired channel.

13. A method for allocating resources for a television converter having at least one channel selecting resource according to claim 12 wherein the anticipated user channel is the previous channel selected by the user.

14. A method for allocating resources for a television converter having at least one channel selecting resource according to claim 11 wherein one channel selecting resource provides television programming for a main channel and the other channel selecting resource provides television programming for a picture-in-picture display for the television display device.

15. A method for allocating resources for a television converter having at least one channel selecting resource according to claim 1 further comprising detecting when a user requests use of said channel selecting resource.

16. A method for allocating resources for a television converter having at least one channel selecting resource according to claim 15 further comprising reallocating said channel selection resource in accordance with such user request.

17. A television converter for use in a home entertainment system comprising:
a channel selecting resource to receive and process television signals;
a remote control interface to receive a user commands from a remote controller;
a connection for connecting the television converter to a display device;
a processor coupled in communication to the channel selecting resource, the remote control interface, and the first storage device;
a first storage device coupled to the channel selecting resource, the control electronics, and the delivery device, the first storage device operable to store television programming and digital data; and
an inactivity detector that monitors at least one parameter of the home entertainment system and determines when the channel selecting resource is inactive based on the parameter.

18. The television converter of claim 17 further comprising:
a second channel selecting resource; and
wherein the inactivity detector determines when any one of the channel selecting resources is inactive based on the parameter.

19. The television converter of claim 17 further comprising:
a power receptacle providing power to the display device; and
wherein the inactivity detector includes an ammeter that monitors the current being drawn by the display device.

20. The television converter of claim 17 further comprising:
a database stored on the first storage device listing commands that can be sent by the remote controller to the display device; and
wherein the inactivity detector determines that a channel selecting resource is inactive based on the commands transmitted by the remote controller to the display device.

21. The television converter of claim 17 further comprising:
a database stored on the first storage device listing commands that can be sent by a remote controller to the television converter, the display device and at least one additional peripheral device; and
wherein the inactivity detector determines that a channel selecting resource is inactive based on the commands transmitted by the remote controller to the at least one peripheral device.

22. The television converter of claim 17, wherein the at least one parameter includes the power state of the television converter.

23. The television converter of claim 17, wherein the at least one parameter includes the power state of the display device.

24. The television converter of claim 17, wherein the at least one parameter includes the source of television programming delivered by the television converter.

25. A satellite set top box for use in a home entertainment system comprising:
a channel selecting resource to receive and process satellite television signals;
a delivery device to deliver television programming to a connected television;
a remote control interface to receive a user commands sent from a remote control;
a connection for connecting the satellite set top box to a television;
a processor coupled in communication to the channel selecting resource, the remote control interface, the delivery device and a first storage device;
the first storage device coupled to the channel selecting resource, the control electronics, and the delivery device, the first storage device operable to store television programming and digital data; and
an inactivity detector that monitors at least one parameter of the home entertainment system and determines when the channel selecting resource is inactive based on the parameter.

26. The satellite set top box of claim 25 further comprising:
a second channel selecting resource; and
wherein the inactivity detector determines when any one of the channel selecting resources is inactive based on the parameter.

27. The satellite set top box of claim 25 further comprising:
a power receptacle providing power to the television; and
wherein the inactivity detector includes an ammeter that monitors the current being drawn by the television.

28. The satellite set top box of claim 25 further comprising:
a database stored on the first storage device listing commands that can be sent by a remote controller to the television; and
wherein the inactivity detector determines that a channel selecting resource is inactive based on the commands transmitted by the remote controller to the television.

29. The satellite set top box of claim 25 further comprising:
a database stored on the first storage device listing commands that can be sent by a remote controller to the television converter, the television and at least one additional peripheral device; and
wherein the inactivity detector determines that a channel selecting resource is inactive based on the commands transmitted by the remote controller to the at least one peripheral device.

30. The satellite set top box of claim 25, wherein the at least one parameter includes the power state of the satellite set top box.

31. The satellite set top box of claim 25, wherein the at least one parameter includes the power state of the television.

32. The satellite set top box of claim 25, wherein the at least one parameter includes the source of television programming delivered by the satellite set top box.

33. The satellite set top box of claim 25 further comprising:
a control panel on the satellite set top box for receiving user commands; and
wherein the at least one parameter includes monitoring commands received via the control panel.

34. The satellite set top box of claim 25, wherein the inactivity detector includes at least one monitoring device that monitors the operation of a peripheral electronic device and at least one parameter includes a parameter related to the peripheral electronic device.
